(19) United States
(12) Patent Application Publication
(10) Pub. No.: US 2018/0341644 A1
(43) Pub. Date: Nov. 29, 2018

(54) Method and system for activating virtual assistants without the presence of the user

(71) Applicant: John Gregory Retkowski, San Diego, CA (US)

(72) Inventor: John Gregory Retkowski, San Diego, CA (US)

(21) Appl. No.: 15/976,277

(22) Filed: May 10, 2018

Related U.S. Application Data
(60) Provisional application No. 62/511,514, filed on May 26, 2017.

(51) Int. Cl. G06F 17/28; G06F 9/451; G10L 15/22

(52) U.S. Cl. CPC G06F 17/28; G10L 13/00; G10L 15/22; G06F 9/453

(57) ABSTRACT

A method and system for users to interact with their virtual assistant without being in the presence of the assistant, and to run commands on that assistant at a different time then when the user issued the command. The user provides a specific time or event, and a command to be run on the virtual assistant. When the time/event occurs the system issues the command to the virtual assistant. Additionally, a method and system for linking devices to virtual assistants using natural language utterances.

### REFERENCE TO RELATED APPLICATIONS

This application claims the priority of U.S. Provisional Application No. 62/511,514, filed on May 26, 2017, the entire contents of which are hereby incorporated by reference.

### BACKGROUND OF THE INVENTION

### Field of the Invention

The present invention relates to a computer method and system for interacting with information processing systems through natural language utterances on behalf of a user, outside of the presence of the user.

### Motivation and Description of Related Art

A virtual assistant refers to any information processing system that interprets natural language input in spoken or textual form to infer user intent, and perform actions based on the inferred user intent. A User can issue a command to the Virtual Assistant in the form of a natural language utterance. The Virtual Assistant then acts upon that command. The typical users of Virtual Assistants are human. However, users could be any agent that invokes a Virtual Assistant to action on their behalf. Nonhuman users, including other Virtual Assistants and computing devices are envisaged to be potential users in the coming years.

As of 2017, the capability and usage virtual assistants is expanding, with several of the largest technology companies providing assistants to their users. Users interact with virtual assistants using voice, text, uploading images—or a combination of input methods. Virtual assistants use natural language processing (NLP) to process user input. Virtual assistants also improve their effectiveness by using machine learning techniques.

Virtual assistants are integrated into many types of platforms, including smartphones, standalone network-connected speakers, instant messaging apps, in appliances, cars, IVR telephone systems, or embedded into websites.

Virtual assistants provide a variety of services. These include: Providing information such as weather and facts. Updating a user's calendar, alarms, or to-do lists. Playing music and reading audiobooks. Playing video programming, either directly on the device or by casting the content to another device over the network. Managing devices in the home such as turning on/off lights, or changing the temperature by interacting with a thermostat.

Virtual assistant platforms often provide methods for third-parties to extend the functionality of the assistant by publishing API's and SDK's.

When a user interacts with a virtual assistant, and gives a command to the assistant, the user must be in the presence of the assistant at the time in which the command is given. Presently, there is no way for a user trigger a command, in the form of a natural language utterance, on a virtual assistant if they are not in the assistant's presence, or to have a system automatically issue the command on their behalf.

### SUMMARY OF THE INVENTION

The embodiments of the present invention provide a method and system for users to interact with their virtual assistant without being in the presence of the assistant, and to run commands on that assistant at a different time than when the user issued the command.

In one aspect of the present invention, the user tells the system by voice, text, or other method that at a specific time, or the occurrence of a specific event, or on a recurring basis, that they want specified command run on their digital assistant. The user provides that command in the form of a natural language utterance. The system stores the command, the time/event, and the identification of the digital assistant. When the triggering time/event occurs the system sends the command to a hardware device located near the digital assistant. The hardware device then speaks the command, triggering the digital assistant to perform the command.

In another aspect of the present invention, to provision the hardware communication device to associate it with the virtual assistant, the hardware communication device interacts with the virtual assistant and the service using voice commands to link the hardware communication device to the virtual assistant.

The above invention aspects will be made clear in the drawings and detailed description of the invention.

### BRIEF DESCRIPTION OF THE DRAWINGS

In the following the invention will be explained as an example by means of an embodiment with the help of the attached drawings.

FIG. 1. is a block diagram of the components and networking environment of certain embodiments of the virtual assistant activation system.

FIG. 2. is a flow diagram demonstrating the flow of a user using an embodiment of the virtual assistant activation system.

FIG. 3. is a flow diagram demonstrating the flow of device provisioning within the system in an embodiment of the virtual assistant activation system.

FIG. 4 is a block diagram showing the system configuration of certain embodiments of the virtual assistant activation system.

FIG. 5 is a flow diagram showing the main steps of activating the virtual assistant in an embodiment of the virtual assistant activation system.

FIG. 6 is a flow diagram showing the main steps of linking the virtual assistant activation system with the virtual assistant in an embodiment of the present invention.

### DETAILED DESCRIPTION OF THE INVENTION

In the detailed description, numerous specific details are set forth in order to provide a thorough understanding of the invention. However, it will be understood by those skilled in the art that these are specific embodiments, and that the present invention may be practiced also in different ways that embody the characterizing features of the invention as described and claimed herein.

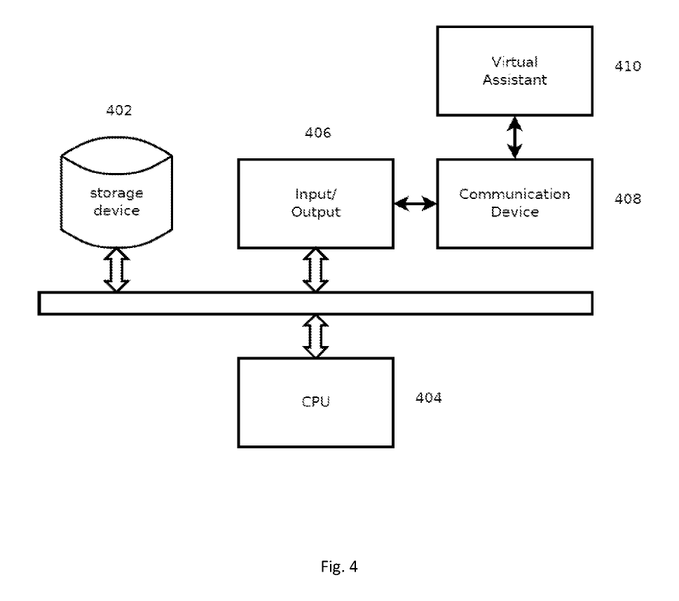

FIG. 4 shows the system configuration of certain embodiments of the present invention. A system for interacting with a virtual assistant 410 on behalf of a user comprises a CPU 404, a storage device 402, an input/output interface 406 and a communication device 408. The system receives instruction from a user via the input/output interface 406 and communicate with the virtual assistant 410 via the communication device 408.

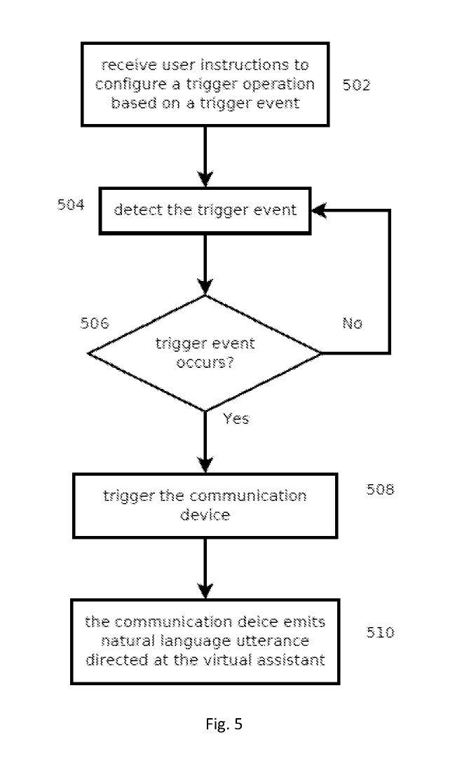

FIG. 5 shows the main steps of activating the virtual assistant. First, the system receives user instructions to configure a trigger operation based on a trigger event (Step 502). The system detects the trigger event (Step 504), and when the event occurs (Step 506), the communication device is triggered (Step 508) to emit natural language utterance directed to the virtual assistant.

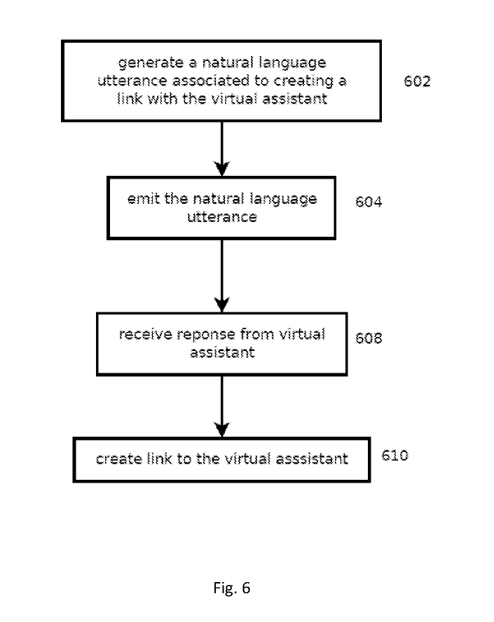

FIG. 6 shows the main steps of linking the system with the virtual assistant. First, the system generates a natural language utterance associated with creating a link with the virtual assistant (Step 602) and emits the natural language utterance (Step 604). Then

the system receives response from virtual assistant (Step 608) and creates a link with the virtual assistant (Step 610).

The portion of the invention which issues commands on behalf of the user has several components, but to ease comprehension, there are three top level components of the invention. One is a system to emit a natural language utterance to a virtual assistant. The second is a trigger scheduling engine which stores and activates triggers, and a third which allows the user to configure the triggers. The embodiments below provide higher detail on how these components are implemented.

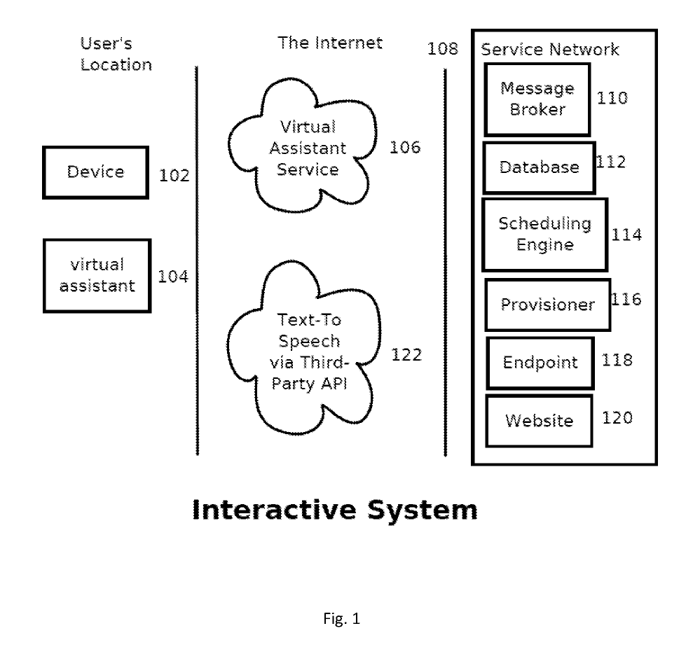

FIG. 1 shows the components and networking environment of some embodiments of the system for interacting with a virtual assistant (Interactive System). A hardware device (Device) 102 is provided per virtual assistant (Assistant) 104, comprising of a computer, a network connection (WiFi or wired), and a speaker. Other embodiments may have software agent running on a system which is not a dedicated hardware device, such as the user's laptop or phone. Other embodiments could make an API call directly to the virtual assistant's API endpoint if the virtual assistant supports this.

The Interactive System comprises a Service Network 108, where the services which communicate with device 102 are located. In certain embodiments, the Service Network resides in a single datacenter. In other embodiments the Service Network is spread across multiple datacenters and cloud infrastructure providers.

The Service Network 108 comprises a Database 112, which stores information about the user, the virtual assistant, and linkages between Devices and virtual assistants.

The Service Network 108 also comprises a trigger scheduling engine (Engine) 114, which can trigger commands based on times or events. In certain embodiments, the UNIX commands ‘cron’ and ‘at’ can be used to trigger these invocations. Other embodiments could use more complex trigger scheduling engines, including workflow engines.

In certain embodiments, a Text-to-Speech system (TTS) 122 is used when the command is stored in a textual representation and the virtual assistant 104 is issued the command in the form of audio speech. This TTS system 122 can be provided by a third party and accessed over an API. Alternative embodiments where the command is provided as a textual representation do not require this TTS component. Alternative embodiments may use a TTS system which is a software running within the service network, or as part of the trigger scheduling engine.

In certain embodiments, the Service Network 108 comprises a message broker service (Broker) 110 which relays commands to the hardware devices. In other embodiments, the trigger scheduling engine 114 can deliver actions to the hardware directly.

In certain embodiments, a virtual assistant API endpoint (Endpoint) 118 is provided, which provides an interface for the user—via the digital assistant's 104 connection to their virtual assistant service 106—to schedule actions.

In certain embodiments, a provisioning service (Provisioner) 116 is provided, a HTTP/REST endpoint is used to provision new devices.

Optionally, a web endpoint (Website) 120 is provided, which allows the user to manage their scheduled actions using a web browser.

Running a Command on the Virtual Assistant without being Present

A user asks their Assistant to talk to the Interactive System. The virtual assistant service connects to the Endpoint 118. The Endpoint communicates with the virtual assistant service using the API defined by the virtual assistant service. In certain embodiments, the Endpoint is a webserver/script which implements the virtual assistant service's API. The API allows the virtual assistant to proxy a conversation between the user and the invention.

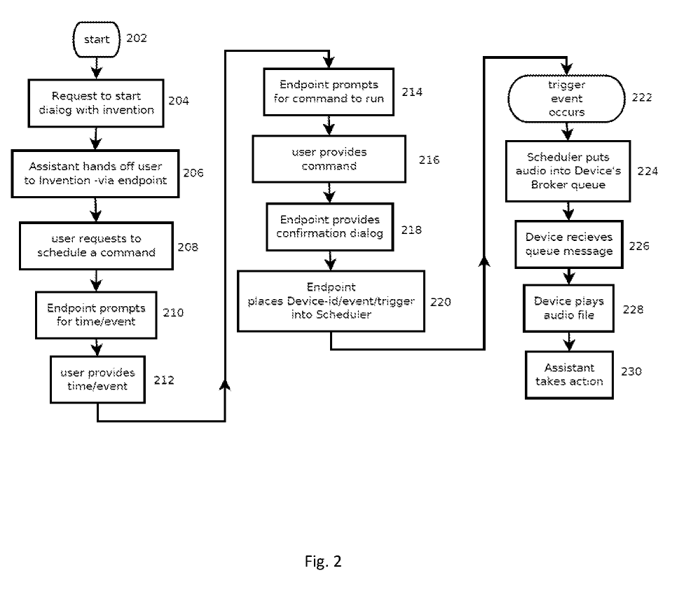

FIG. 2 shows the process of a user using an embodiment of the Interactive System. When the user requests to start dialog with the Interactive System (Step 204), the Assistant hands off user to the Interactive System via Endpoint (Step 205). The user requests to schedule a command (Step 208). Endpoint then prompts for time/event (Step 210). The user provides time/event (Step 212). Next, Endpoint prompts for command to run (Step 214). And the user provides command (Step 216). Next, the Endpoint provides confirmation dialog (Step 218). And the Endpoint places Device-id/event/trigger into the Scheduler (Step 220). When the trigger event occurs (Step 222), the Scheduler puts audio into the Device's broker queue (Step 224). When the Device receives queue message (Step 226), the Device plays audio file (Step 228), and the Assistant takes action (Step 230).

In certain embodiments, the name of the service/invention is used—either spoken or written—when interacting with virtual assistants. In the descriptions below it will be indicated by the string ‘Invention’.

Below is an example of a conversation among the user, the Interactive System, and Assistant:

User: talk to Invention (Step 202)

Assistant: Sure, here's ‘Invention’ (Step 206)

Interactive System: If you would like to schedule a command, say ‘schedule a command’

User: Schedule a command (Step 208)

Interactive System: What time would you like to run the command? (Step 210)

User: At five thirty PM (Step 212)

Interactive System: What command would you like to run? (Step 214)

User: Set the temperature to sixty five degrees (Step 216)

Interactive System: OK, at 5:30 PM I will run ‘Set the temperature to sixty five degrees’ (Step 218)

After the user interaction, Endpoint 118 has sufficient information to schedule the command. It uses the information it has stored in the Database to identify the correct Device to run the command, the time/event to trigger the command, and a string representation of the command. It then passes to the Engine the Device identifier, time/event, and command information (Step 220).

The Engine then stores the Device ID, time/event, and command information. When an event/time triggers (Step 222)—the Engine calls a script which first makes an API call to a third-party text-to-speech service 122 which converts the command to an audio file. It then publishes the audio file to a specific Broker queue dedicated to the Device associated with the user's Assistant (Step 224).

The Device 102 listens for messages on the Broker queue dedicated to its virtual assistant. When a message arrives with an attached audio file (Step 226), the Device plays the audio file on its speaker (Step 228). This audio file invokes the desired command on the virtual assistant (Step 230).

Below is an example conversation between the Device and the Assistant:
At 5:30 PM: (Step 222)
Device (spoken): [trigger word], Set the temperature to sixty five degrees. (Step 228)
Assistant: OK, Setting the thermostat to sixty five degrees. (Step 230)
(assistant changes thermostat to 65 degrees)

Other than Time-Based Event Triggers

The above embodiment shows how a time-based event trigger works. Other event triggers can be used by the user. Examples include, but are not limited to:

By obtaining the geographic location of the virtual assistant, the service can use sunrise/sunset times as triggers, or current weather conditions as triggers.

The service may monitor a social networking service, news site, or other type of site, and messages on these sites containing specific content or keywords may be used as a trigger.

Users may allow third-parties to push notifications to their virtual assistants by allowing the third-parties to trigger events by webhooks or other methods.

Users may use the presence of an incoming message, such as email, social networking, text, or chat message to as trigger events.

In other embodiments of the invention, a single computing device may contain all the components of the Interactive System.

In other embodiments, the hardware device may contain multiple programs. One software program takes the text form of an utterance, converts it into audio using a Text-To-Speech system, and then plays that audio on a speaker. Another program on the same device may store information about the triggering events, detect the passage of a triggering event, and invoke the utterance subsystem. A third program on the device may allow the user to configure the triggers and utterances using a web browser.

In other embodiments, multiple programs may be combined into a single program.

In a variation of the above embodiments, the device may receive user's voice commands, either directly or by way of the virtual assistant's API—and use the content of the user's voice input to configure the triggers and utterances.

In other embodiments, the triggering system may be built into the virtual assistant's provider's service network, as well as the configuration and storage of triggers. The provider's trigger system may invoke the virtual assistant over an API call, or by issuing a textual version of the utterance to the virtual assistant, or play a text-to-speech audio file on the virtual assistant's speaker which the virtual assistant responds to.

Provisioning the Device

When a new Device 102 is provisioned it must be linked with the nearby virtual assistant 104. In some embodiments, to perform the linking, the following actions take place.

First the device is connected to the same network as the virtual assistant, and physically placed next to the virtual assistant.

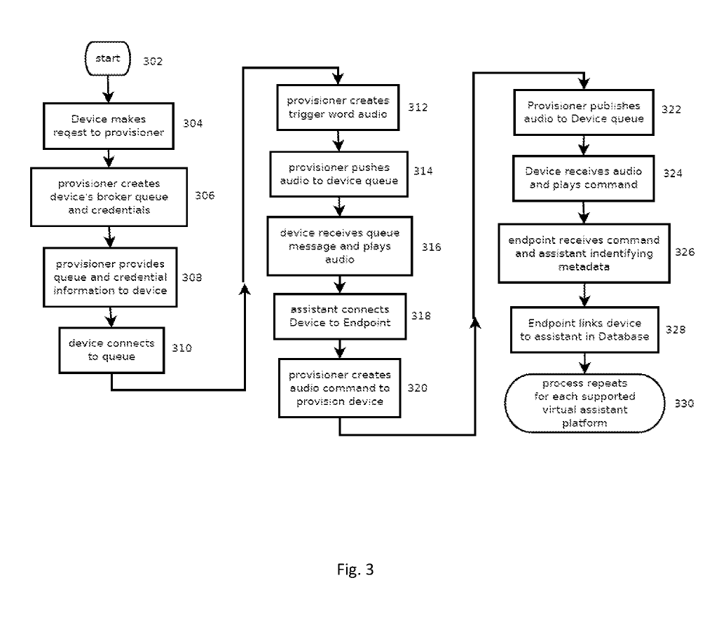

The Device makes a HTTP/REST request to the Provisioner, requesting that it be provisioned, and includes its unique device identifier (Step 304 in FIG. 3). In some embodiments, the identifier is derived from the MAC address of the Device. The Provisioner creates a Broker queue dedicated to the Device, and generates credentials which grants the Device permission to read from the queue (Step 306). The Provisioner responds to the Device, including the connection information for the queue and the credentials for the queue (Step 308).

The Device then connects to the queue (Step 310).

For each virtual assistant platform, the service supports:
The Provisioner creates an audio file, containing the voice commands, which is the ‘trigger word’ for the assistant service, and a command to ‘talk to Invention’ (Step 312).
The Provisioner sends an audio file down the queue for the Device (Step 314).
The Device plays the audio file (Step 316).
The audio instructs the virtual assistant to proxy the conversation between the Device and the Endpoint (Step 318).
The Provisioner then sends and audio file down the queue of the Device, which contains a string to provision the device (Steps 320 and 322). An example string is the following:
‘provision device charlie seven three five charlie echo foxtrot delta eight alpha alpha one’
The Device reads the audio file from the queue and plays it (Step 324).

When the virtual assistant proxies a conversation, it sends metadata identifying the virtual assistant. The Endpoint receives the proxied ‘provision device’ command, and uses the virtual assistant identification metadata to link the virtual assistant to the Device in the Database (Steps 326 and 328).

The Provisioner repeats this process for the remaining supported virtual assistant platforms (Step 330).

In alternate embodiments, the provisioning string may contain a string of arbitrary words instead of a direct representation of the device identification. As long as this set of arbitrary words is unique to the device at the time of linking, the device can be unambiguously linked to the virtual assistant.

In other embodiments, the linking audio can be provided to the Device as part of the initial HTTP/REST exchange with the Provisioner, prior to connection to the Broker queue.

In other embodiments, the computing device itself generates the unique utterance, and has access to the Virtual Assistant's provider's service network. It registers as an API endpoint for a specific app on the virtual assistant. It then generates the utterance using a local text-to-speech engine, plays the utterance using a speaker, then awaits an API call from the virtual assistant's service network which contains metadata about the Device's utterance along with metadata that identifies the virtual assistant.

In another embodiment, the virtual assistants' provider generates the provisioning audio by using a text-to-speech engine to generate it. Then the prover provides it to the Device. The Device plays the audio file to the virtual assistant. The virtual assistant passes the audio to servers on the provider's service network. Those servers use the audio to identify and link the device to the virtual assistant.

The foregoing description and accompanying drawings illustrate the principles, preferred or example embodiments, and modes of assembly and operation, of the invention; however, the invention is not, and shall not be construed as being exclusive or limited to the specific or particular embodiments set forth hereinabove.

What is claimed is:

1. A system for interacting with an information processing system on behalf of a user, comprising:
a storage device storing a set of instructions,
a communication device configured to emit a natural language utterance,
at least one processor configured to communicate with the storage device and the communication device; wherein when executing the set of instructions, the at least one processor is configured to direct the system to perform actions comprising:
receiving user instructions to configure a trigger operation based on a specified triggering event;
when the specified triggering event occurs, triggering the communication device;
when the communication device is triggered, emitting a natural language utterance directed at the information processing system.

2. The system for interacting with an information processing system on behalf of a user according to claim 1, wherein the natural language utterance is one of: a spoken phrase or an audio file.

3. The system for interacting with an information processing system on behalf of a user according to claim 1, wherein the natural language utterance is in textual form.

4. The system for interacting with an information processing system on behalf of a user according to claim 1, wherein the triggering event is a one-time event.

5. The system for interacting with an information processing system on behalf of a user according to claim 1, wherein the is a recurring event.

6. The system for interacting with an information processing system on behalf of a user according to claim 1, wherein the triggering event is based on a time and date.

7. The system for interacting with an information processing system on behalf of a user according to claim 1, wherein the triggering event is generated by one or more computing devices.

8. The system for interacting with an information processing system on behalf of a user according to claim 1, wherein one or more triggering operations are stored within the storage device of the system.

9. A method implemented on a computing device having a storage device storing a set of instructions, a communication device, and at least one processor communicated with the storage device, the method comprising:
receiving user instructions to configure a trigger operation based on a specified triggering event;
when the specified triggering event occurs, triggering a communication device;
when the communication device is triggered, emitting a natural language utterance directed at an information processing system.

10. The method according to claim 9, wherein the natural language utterance is a spoken phrase or an audio file.

11. The method according to claim 9, wherein the natural language utterance is in textual form.

12. The method according to claim 9, wherein the triggering event is a one-time event.

13. The method according to claim 9, wherein the is a recurring event.

14. The method according to claim 9, wherein the triggering event is based on a time and date.

15. The method according to claim 9, wherein the triggering event is generated by one or more computing devices.

16. The method according to claim 9, wherein one or more triggering operations are stored within the storage device of the computing device.

17. A computing device for interacting with an information processing system on behalf of a user, comprising:
a storage device storing a set of instructions,
at least one processor configured to communicate with the storage device, wherein when executing the set of instructions, the at least one processor is configured to direct the system to perform actions comprising:
generating a natural language utterance, the natural language utterance specifically associated to the action of creating a link with the information processing system;
emitting the natural language utterance directed at the information processing system;
receiving communication from the information processing system after the emission of the natural utterance;
linking the computing device with the information processing system.

18. A method implemented on a computing device having a storage device storing a set of instructions, and at least one processor communicated with the storage device, the method comprising:
generating a natural language utterance, the natural language utterance is specifically associated to the action of creating a link with an information processing system;
emitting the natural language utterance directed at the information processing system;
receiving communication from the information processing system after the emission of the natural utterance;
linking the computing device with the information processing system.

19. The method according to claim 18, wherein the natural language utterance a spoken phrase or an audio file.

20. The method according to claim 18, wherein the communication contains identifying information of both the computing device and the information processing system.

21. The method according to claim 18, wherein the natural language utterance is an attribute of the device or an arbitrary list of words.
